(19) United States
(12) Patent Application Publication
(10) Pub. No.: US 2010/0300854 A1
(43) Pub. Date: Dec. 2, 2010

(54) Integrated Luminous Keyboard

(76) Inventors: Shih-Chou CHEN, Hsinchu Industrial Park (TW); Yuh-Sheng Lin, Hsinchu Industrial Park (TW); Kung-Yeh Tou, Hsinchu Industrial Park (TW); Chien-Hua Chiu, Hsinchu Industrial Park (TW)

Correspondence Address: Muncy, Geissler, Olds & Lowe, PLLC, 4000 Legato Road, Suite 310, FAIRFAX, VA, 22033, US

(21) Appl. No.: 12/276,347

(22) Filed: Nov. 23, 2008

(51) Int. Cl. H01H 9/00

(52) U.S. Cl. 200/310

(57) ABSTRACT

The present invention relates to an integrated luminous keyboard, and includes a plurality of keys, light sources, a flexible circuit board, a light guide plate and a reflector plate, wherein the flexible circuit board, which enables detecting key signals from the keys, is located underneath the keys. A plurality of slots, used to fixedly secure the keys, are defined in the light guide plate corresponding to the keyboard. Moreover, the light guide plate enables the incoming of light rays produced by the light sources, and the reflector plate is located underneath the light guide plate. Accordingly, use of the light guide plate of the present invention simultaneously provides the effectiveness to fixedly secure the keys and realize a luminescent effect, thereby eliminating disposition of a bottom plate structure of prior art luminous keyboards, and achieves the practical advancements of simplification and lightweighting of the structure, and saving on costs.

### BACKGROUND OF THE INVENTION

(a) Field of the Invention

The present invention provides a luminous keyboard, and more particularly provides an integrated luminous keyboard which directly replaces a bottom plate with a light guide plate.

(b) Description of the Prior Art

Currently, many keyboard structures are equipped with multiple colored light sources to achieve multicolor luminescent effects, thereby effectively achieving being able to identify the keys on the keyboard or improve the characteristic appearance of the keyboard at night or in places where the lighting is inadequate.

Referring to FIG. 1, which shows an elevational view of a luminous keyboard structure of the prior art, and it can be clearly seen from the drawing that a luminous keyboard structure 1 of the prior art comprises light sources 11, a plurality of keys 12, a flexible circuit board 13, a bottom plate 14, a light guide plate 15 and a reflector plate 16, wherein the flexible circuit board 13 is disposed underneath the keys 12, and is used to detect the key signals from the keys 12. The bottom plate 14 is disposed underneath the flexible circuit board 13, and is used to fixedly secure the keys 12. The light guide plate 15 is disposed underneath the bottom plate 14, and is used to enable the incoming of light rays emitted by the light source 11. A plurality of rough surfaces are defined on the bottom portion of the light guide plate 15, and the reflector plate 16 is located underneath the light guide plate 15. Accordingly, when light rays emitted by the light source 11 enter the light guide plate 15, then disposition of the rough surfaces causes the paths of the light rays to change, and further causes diffuse reflection of the light rays towards the keys 12, thereby enabling the keyboard to achieve a luminescent effect.

However, the following problems and shortcomings are still in need of improvement when using the aforementioned luminous keyboard structure 1 of the prior art:

The luminous keyboard structure 1 of the prior art comprising the light sources 11, the plurality of keys 12, the flexible circuit board 13, the bottom plate 14, the light guide plate 15 and the reflector plate 16 is excessively complex, and, in the intense commercial competition of modern times, has not been in keeping with economic effectiveness for some time already. Moreover, cost is excessively high.

Hence, it is the strong desire of the inventor and manufacturers engaged in related art and purpose of the present invention to research, resolve and improve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new integrated luminous keyboard which directly replaces a bottom plate with a light guide plate.

A primary objective of the present invention lies in: A luminous keyboard of the present invention comprising a plurality of keys, light sources, a flexible circuit board, a light guide plate and a reflector plate, wherein the flexible circuit board is disposed underneath the keys, and enables detecting key signals from the keys. The light guide plate is disposed underneath the flexible circuit board, and enables the incoming of light rays produced by the light sources. Moreover, a plurality of slots are defined in the light guide plate corresponding to the keyboard, and are used to fixedly secure the keys, and the reflector plate is located underneath the light guide plate. Hence, because the light guide plate of the present invention is simultaneously provided with the effectiveness to fixedly secure the keys and realize a luminescent effect, thus, the need for disposition of a bottom plate is eliminated. According to the art described above, the present invention provides a breakthrough in solving the existing problems of the structures of luminous keyboards of the prior art being excessively complex, and achieves the practical advancement of directly replacing the bottom plate with the light guide plate.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of a luminous keyboard structure of the prior art.

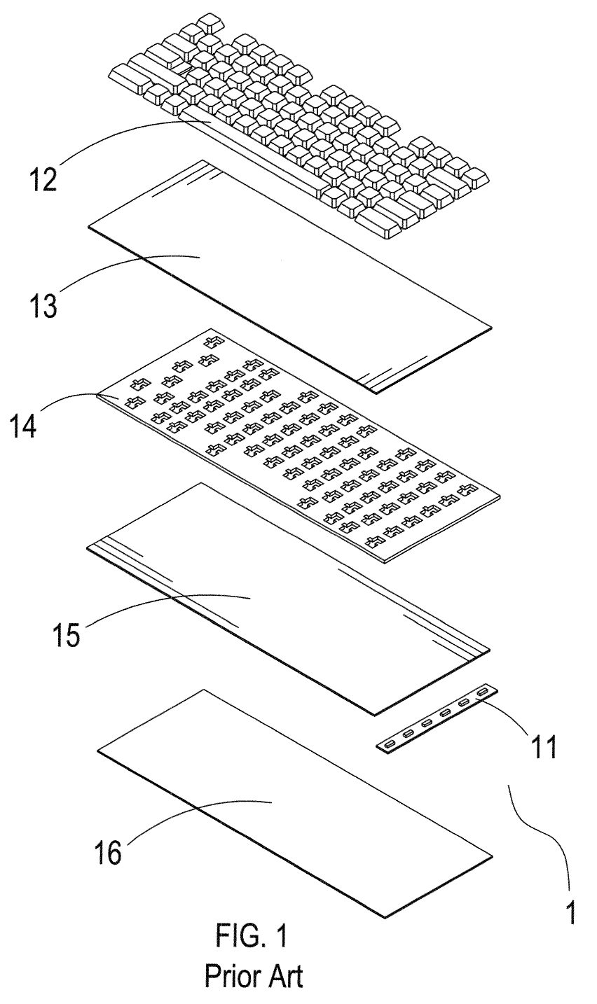

FIG. 2 shows an elevational view of a preferred embodiment of the present invention.

FIG. 3 shows an exploded elevational view of the preferred embodiment of the present invention.

FIG. 4 shows a side view of the preferred embodiment of the present invention.

FIG. 5 shows an implementation schematic view of the preferred embodiment according to the present invention.

FIG. 6 shows an implementation schematic view of another preferred embodiment according to the present invention.

### DETAILED DESCRIPTION OF THE PREFERRED EMBODIMENTS

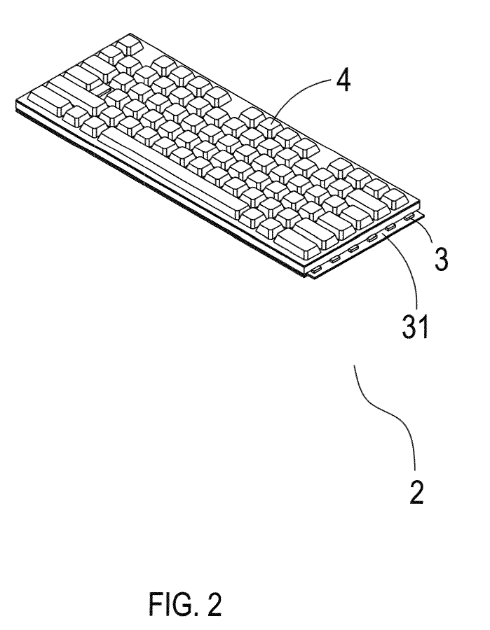

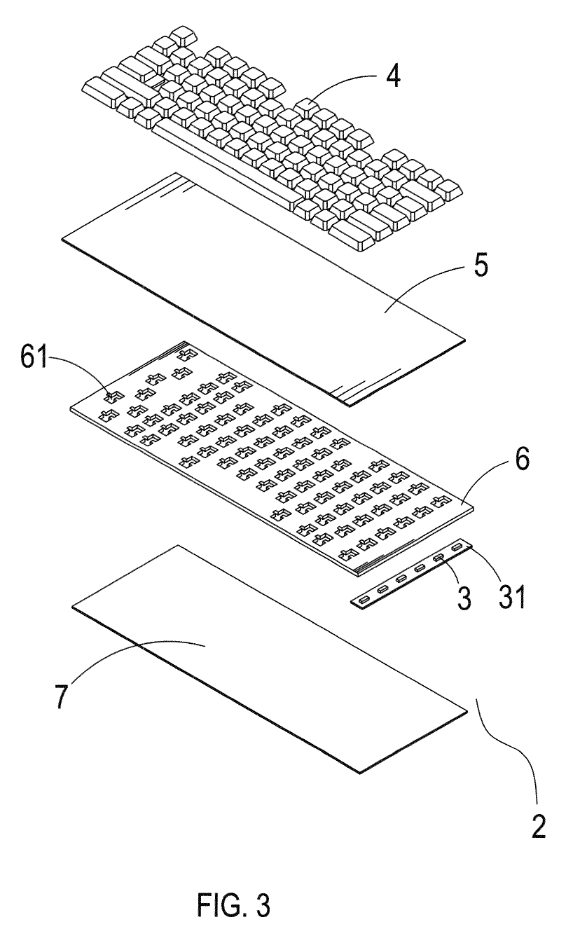

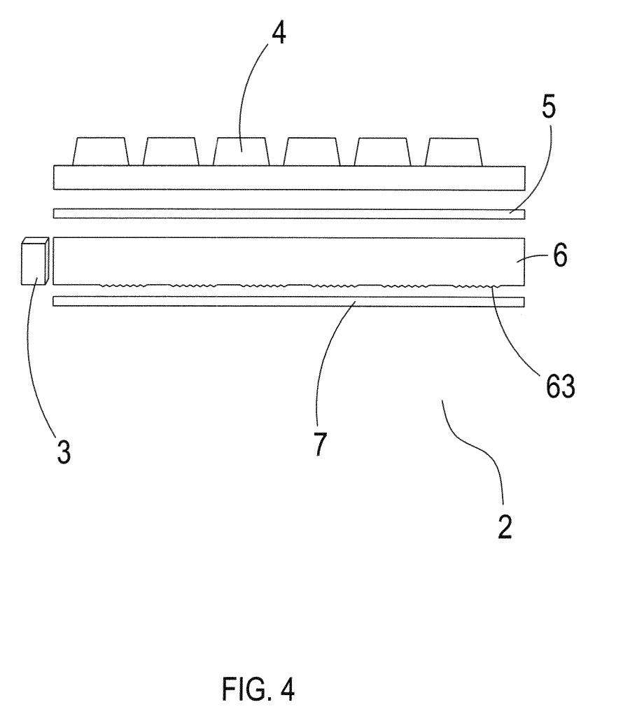

Referring to FIG. 2, FIG. 3 and FIG. 4, which show an elevational view, an exploded elevational view and a side view respectively of a preferred embodiment of the present invention, and it can be clearly seen from the drawings that a luminous keyboard 2 of the present invention comprises:

A plurality of keys 4;

At least one light source 3, and the light sources 3 can be one of the following light-emitting elements: light-emitting diodes, CCFLs (Cold Cathode Fluorescent Lamps) or electroluminescent strips. The light sources 3 are disposed on a base plate 31;

A flexible circuit board 5, which is disposed underneath the keys 4, and enables detecting key signals from the keyboard;

A light guide plate 6, and the light guide plate 6 enables the incoming of light rays produced by the light sources 3; moreover, a plurality of slots 61 are defined in the light guide plate 6 corresponding to the keyboard, and are used to fixedly secure the keys 4. A plurality of rough surfaces 63 are defined on the bottom portion of the light guide plate 6;

A reflector plate 7, which is located underneath the light guide plate 6, and the reflector plate 7 enables reflecting of light rays.

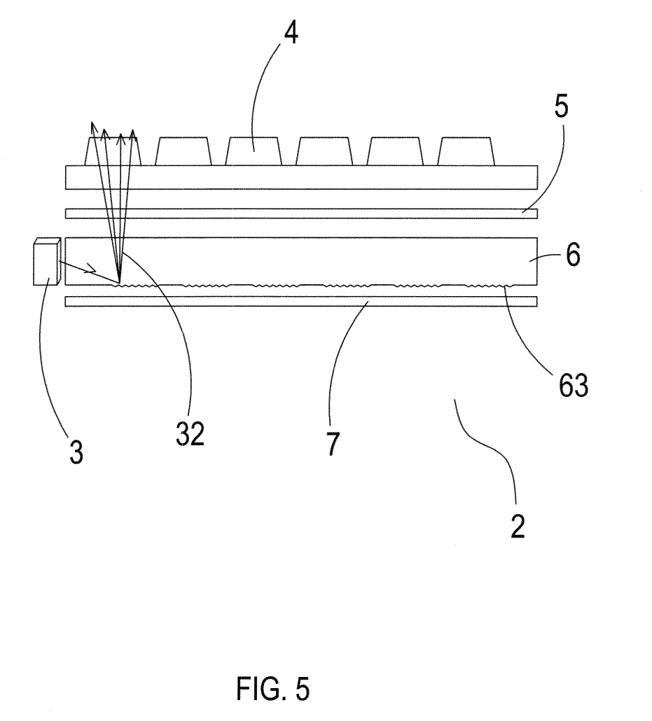

According to the aforementioned structure and constructional design, circumstances during operational use of the present invention are described hereinafter. Referring together to FIG. 3 and FIG. 5, which show the exploded elevational view and an implementation schematic view respectively of the preferred embodiment according to the present invention, and it can be clearly seen from the drawings that when light rays 32 produced by the light sources 3 of the luminous keyboard 2 of the present invention enter the light guide plate 6, because of the plurality of rough surfaces 63 defined on the bottom portion of the light guide plate 6, thus, the illumination paths of the light rays 32 illuminating the rough surfaces 63 are changed causing diffuse reflection of the light rays 32 towards the keys 4, thereby providing the keys 4 with a luminescent effect.

Furthermore, the luminous keyboard 2 of the present invention comprising the plurality of keys 4, the light sources 3, the flexible circuit board 5, the light guide plate 6 and the reflector plate 7, because the light guide plate 6 of the present invention uses the plurality of slots 61 defined therein corresponding to the keyboard to fixedly secure the keys 4, thus, the present invention eliminates the need for a bottom plate to be fitted to fixedly secure the keys 4. Hence, the light guide plate 6 of the present invention simultaneously provides effectiveness to fixedly secure the keys 4 and enables the incoming of the light rays 32, thereby enabling omitting the bottom plate of luminous keyboard structures of the prior art, and achieving the practical advancements of simplification of structure and saving on costs.

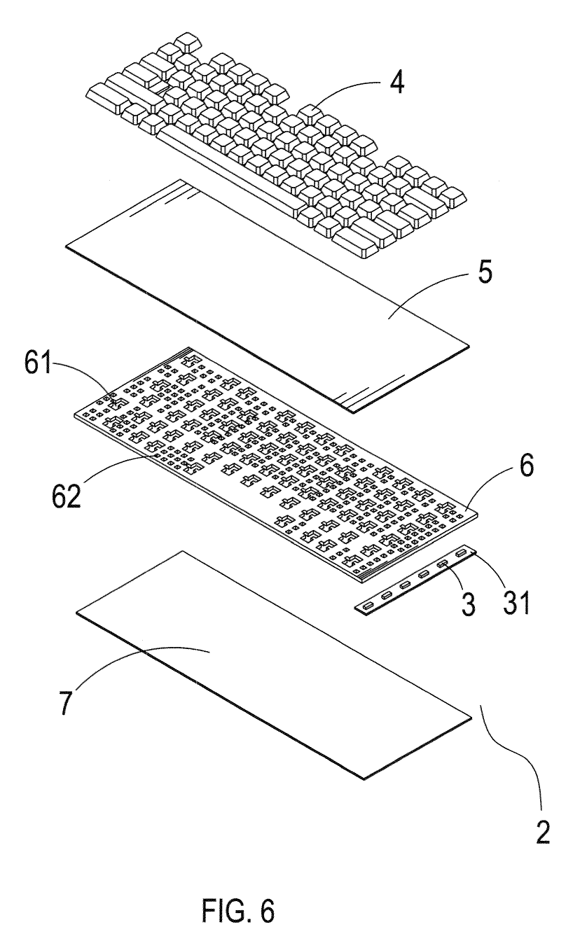

Referring, to FIG. 6, which shows an implementation schematic view of another preferred embodiment according to the present invention, and it can be clearly seen from the drawing that a plurality of holes 62 are defined at appropriate places in the light guide plate 6 of the present invention, and the holes 62 are defined at non-luminescent areas of the keys 4, thereby achieving the effectiveness of lightweighting the luminous keyboard 2.

Hence, referring to all the drawings, compared to the prior art, the following advantages exist when using the present invention:

The luminous keyboard 2 of the present invention comprises the plurality of keys 4, the light sources 3, the flexible circuit board 5, the light guide plate 6 and the reflector plate 7, wherein the flexible circuit board 5 is located underneath the keys 4 and enables detecting key signals from the keys 4. The plurality of slots 61 are defined in the light guide plate 6 corresponding to the keyboard, and are used to fixedly secure the keys 4. Moreover, the light guide plate 6 enables the incoming of the light rays 32 produced by the light sources 3, and the reflector plate 7 is located underneath the light guide plate 6. Hence, according to the structure described above, the light guide plate 6 of the present invention simultaneously provides effectiveness to fixedly secure the keys 4 and enable the incoming of the light rays 32, thereby enabling omitting the bottom plate of luminous keyboard structures of the prior art, and achieving the practical advancements of simplification and lightweighting of the structure, and saving on costs.

In conclusion, the integrated luminous keyboard of the present invention is clearly able to achieve the effectiveness and objectives as disclosed when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims,

What is claimed is:

1. An integrated luminous keyboard, comprising:
at least one light source;
a plurality of keys;
a flexible circuit board located underneath the keys, and the flexible circuit board enables detecting key signals from the keyboard;
a light guide plate enabling the incoming of light rays produced by the light sources, and the light guide plate enables fixedly securing the keyboard; and
a reflector plate located underneath the light guide plate.

2. The integrated luminous keyboard according to claim 1, wherein a plurality of slots are defined in the light guide plate corresponding to the keyboard, thereby enabling the keys to be fixedly secured.

3. The integrated luminous keyboard according to claim 1, wherein the light sources are one of the following light-emitting elements: light-emitting diodes, CCFLs (Cold Cathode Fluorescent Lamps) or electroluminescent strips.

4. The integrated luminous keyboard according to claim 1, wherein the light sources are disposed on a base plate.

5. The integrated luminous keyboard according to claim 1, wherein a plurality of holes penetrate appropriate places of the light guide plate, thereby achieving lightweighting effectiveness.

6. The integrated luminous keyboard according to claim 1, wherein a plurality of rough surfaces are defined on the bottom portion of the light guide plate.
